(19) United States
(12) Patent Application Publication
(10) Pub. No.: US 2026/0301306 A1
(43) Pub. Date: Oct. 1, 2026

(54) SYSTEMS AND METHODS FOR SYNTHETIC ENTITY AUGMENTATION IN AUTONOMOUS VEHICLE PERCEPTION SYSTEMS

(71) Applicant: AVRIDE Inc., Newburyport, MA (US)

(72) Inventors: Igor Olkhovskii, Austin, TX (US); Mikhail Surtsukov, Tel Aviv (IL); Andrey Rykov, Austin, TX (US)

(21) Appl. No.: 19/578,622

(22) Filed: Mar. 25, 2026

Related U.S. Application Data
(60) Provisional application No. 63/777,200, filed on Mar. 25, 2025.

(51) Int. Cl. G06T 15/06; G01S 17/86; G01S 17/89; G01S 17/931; G06T 15/10

(52) U.S. Cl. CPC G06T 15/06; G01S 17/86; G01S 17/89; G01S 17/931; G06T 15/10

(57) ABSTRACT

In some aspects, the techniques described herein relate to systems and methods for synthetic entity augmentation in autonomous vehicle perception systems, the system including: at least one processor; and a memory, wherein the memory contains instructions configuring the at least one processor to: select an entity model from an entity model database; receive from an autonomous vehicle, a plurality of real-world LIDAR data and real-world camera data; and insert the entity model into the 3D space to form augmented data, wherein inserting the entity model into the 3D space includes: performing an RGB ray-casting procedure including updating RGB image pixels with pixels from the inserted entity model; and performing a LIDAR ray-casting procedure.

### CROSS-REFERENCE TO RELATED APPLICATIONS

This application claims the benefit of priority to U.S. Provisional Application No. 63/777,200, filed on Mar. 25, 2025, and entitled “SYSTEM AND METHOD FOR SYNTHETIC RARE ENTITY AUGMENTATION AND ENHANCED PERCEPTION IN AUTONOMOUS VEHICLE PERCEPTION SYSTEMS,” which is incorporated herein by reference in its entirety.

### BACKGROUND OF THE INVENTION

Traditional autonomous vehicle perception systems use extensive manual scene labeling for detection performances. However, these systems employed fail to provide real-world data for rare objects, and fail to insert the objects into scenes such that they can be used to train and improve detection systems. Additionally, conventional detections systems fail to respond accurately when confronted with rare objects.

Therefore, the need exists for a system that provides a method for realistic insertion of objects into existing scenes to improve the accuracy of detection algorithms. The present disclosure meets this need.

### SUMMARY

In some aspects, the techniques described herein relate to a system for synthetic entity augmentation in autonomous vehicle perception systems, the system including: at least one processor; and a memory, wherein the memory contains instructions configuring the at least one processor to: select an entity model from an entity model database; receive from an autonomous vehicle, a plurality of real-world LIDAR data and real-world camera data, wherein the real-world LIDAR data and real-world camera data describe a three-dimensional (3D) space at least partially surrounding the autonomous vehicle; insert the entity model into the 3D space to form augmented data, wherein inserting the entity model into the 3D space includes: performing an RGB ray-casting procedure including updating RGB image pixels with pixels from the inserted entity model; and performing a LIDAR ray-casting procedure, including: determining a plurality of projected LIDAR points, wherein the plurality of projected LIDAR points include locations where rays from the LIDAR system of the autonomous vehicle would intersect the entity model, as a function of LIDAR system parameters and an entity location; determining depth values for each of the projected LIDAR points as a function of the LIDAR mask; and geometrically model, as a function of the depth values and the projected LIDAR points, return locations for LIDAR rays that hit the projected LIDAR points.

In some aspects, the techniques described herein relate to a method for synthetic entity augmentation in autonomous vehicle perception systems, the method including: selecting, using at least one processor, an entity model from an entity model database; receiving, using the at least one processor, from an autonomous vehicle, a plurality of real-world LIDAR data and real-world camera data, wherein the real-world LIDAR data and real-world camera data describe a three-dimensional (3D) space at least partially surrounding the autonomous vehicle; inserting, using the at least one processor, the entity model into the 3D space to form augmented data, wherein inserting the entity model into the 3D space includes: performing an RGB ray-casting procedure including updating RGB image pixels with pixels from the inserted entity model; and performing a LIDAR ray-casting procedure, including: determining a plurality of projected LIDAR points, wherein the plurality of projected LIDAR points include locations where rays from the LIDAR system of the autonomous vehicle would intersect the entity model, as a function of LIDAR system parameters and an entity location; determining depth values for each of the projected LIDAR points as a function of the LIDAR mask; and geometrically model, as a function of the depth values and the projected LIDAR points, return locations for LIDAR rays that hit the projected LIDAR points.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 shows, an exemplary embodiment of system for synthetic entity augmentation in autonomous vehicle perception systems;

FIG. 2 shows an exemplary entity model;

FIG. 3 shows an exemplary data mask;

FIG. 4 shows an exemplary embodiment of a plurality of projected LIDAR points on an entity model;

FIG. 5 shows an exemplary embodiment of a 3D space;

FIG. 6 shows an exemplary embodiment of a light detection and ranging (LIDAR) system;

FIGS. 7A and 7B show an exemplary vehicle computing architecture;

FIG. 8 shows an exemplary machine-learning module;

FIG. 9 shows an exemplary neural network;

FIG. 10 shows a method for synthetic entity augmentation in autonomous vehicle perception systems; and

FIG. 11 shows an exemplary embodiment of a computing device in the exemplary form of a computer system.

### DETAILED DESCRIPTION

### Definitions

As used herein, each of the following terms has the meaning associated with it in this section. Unless defined otherwise, all technical and scientific terms used herein generally have the same meaning as commonly understood by one of ordinary skill in the art to which this disclosure belongs. Generally, the nomenclature used herein are those well-known and commonly employed in the art. It should be understood that the order of steps or order for performing certain actions is immaterial, so long as the present teachings remain operable. Any use of section headings is intended to aid reading of the document and is not to be interpreted as limiting; information that is relevant to a section heading may occur within or outside of that particular section. All publications, patents, and patent documents referred to in this document are incorporated by reference herein in their entirety, as though individually incorporated by reference.

In the application, where an element or component is said to be included in and/or selected from a list of recited elements or components, it should be understood that the element or component can be any one of the recited elements or components and can be selected from a group consisting of two or more of the recited elements or components.

In the methods described herein, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used herein, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

As used herein, the term “ratio” refers to a relationship between two numbers (e.g., scores, summations, and the like). Although, ratios can be expressed in a particular order (e.g., a to b or a:b), one of ordinary skill in the art will recognize that the underlying relationship between the numbers can be expressed in any order without losing the significance of the underlying relationship, although observation and correlation of trends based on the ration may need to be reversed. For example, if the values of a over time are (4, 10) and the values of b over time are (2, 4), the ratio a:b will equal (2, 2.5), while the ratio b:a will be (0.5, 0.4). Although the values of a and b are the same in both ratios, the ratios a:b and b:a are inverse and increase and decrease, respectively, over the time period.

For the purposes of this disclosure, an “entity model,” is an object model that describes its shape and visual appearance based on sensor data. An object may be an agent (any road user, such as a pedestrian, vehicle, or animal) or any spatially localized movable or static obstacle (for example, a road infrastructure element such as a traffic cone or a temporary barrier)..

A “LIDAR mask,” for the purposes of this disclosure, is a data layer that separates LIDAR points between the target object and the remaining scene.

An “RGB mask,” for the purposes of this disclosure, is a data layer separates RGB data between the target object and the remaining scene.

For the purposes of this disclosure, a “rare entity” is an object, person, or being that is not commonly encountered by an autonomous vehicle within the context of its environment.

A “collection distance,” for the purposes of this disclosure, is a distance between a datapoint or model and a sensor that collected it.

For the purposes of this disclosure, an “autonomous vehicle” is a device that is capable of moving people or things from one point to another in a manner that relies primarily on computer algorithms to guide and control the vehicle.

An “insertion position,” for the purposes of this disclosure is a location at which a model is desired to be inserted into a 3D space.

### Detailed Description

The present invention is directed generally to a method and apparatus for enhancing the perception of rare entities in autonomous vehicle preparation systems and, more particularly, to a system and method for synthetic entity augmentation and enhanced perception in autonomous vehicle perception systems. Existing solutions do not accurately insert entities into existing labeled scenes which evidences a disadvantage and challenge of using limited real-word data for rare objects that would successful be detected and interpreted by the detection system.

The present disclosure relates to autonomous vehicles and their operation in various environments. The present disclosure further relates to a system and method for enhancing the perception of rare entities in autonomous vehicle systems through synthetic data augmentation. The present disclosure also includes a method of physically realistic insertion of objects into existing labeled scenes. Furthermore, the present disclosure includes leveraging pre-labeled rare entity or other entity models.

While aspects of this disclosure may specifically discuss the use of rare entity models, this disclosure can be applied beyond rare entity models. For example, this disclosure may be used to address object imbalances. For example, if a vehicle is more likely to encounter one type of object compared to another, the entity insertion described herein may be used to address this imbalance. In some embodiments, this disclosure may be used to place entities in "unrealistic, but possible in principle” environments. As a non-limiting example, it is extremely unlikely and hopefully unrealistic to encounter a baby stroller in the middle of a highspeed highway, but not impossible. In some embodiments, the present disclosure may be used to stresstes detection algorithms, placing "unrealistic, but possible in principle combinations of objects" (E.g. placing 1000 baby strollers on a single scene). Provided herein are systems and methods for synthetic entity augmentation in autonomous vehicle perception systems.

### System for Synthetic Entity Augmentation in Autonomous Vehicle Perception Systems

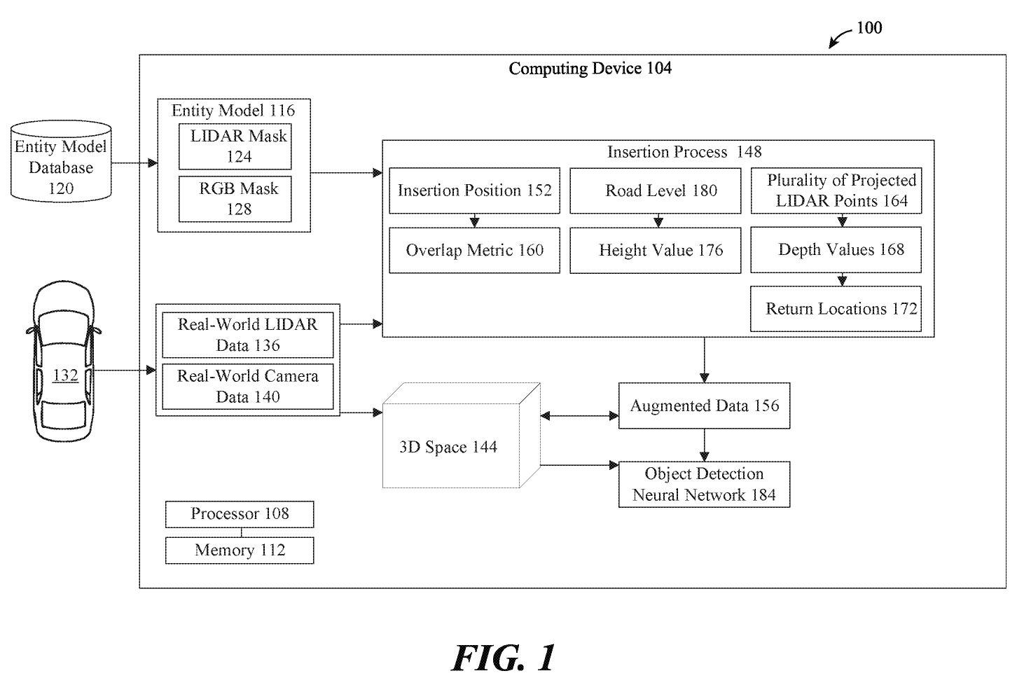

Referring now to FIG. 1, an exemplary embodiment of system 100 for synthetic entity augmentation in autonomous vehicle perception systems is illustrated. System 100 may include circuitry such as without limitation a processor communicatively connected to a memory; for instance, circuitry may include and/or be included in a computing device. As used in this disclosure, “communicatively connected” means connected by way of a connection, attachment, or linkage between two or more relata such as without limitation electronic components, modules, and/or devices which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Circuitry may alternatively or additionally be implemented by configuring a hardware device such as a combinatorial or sequential logic circuit, an application-specific integrated circuit (ASIC), a field-programmable gate array (FPGA), or other hardware unit; memory may be attached thereto to further configure the hardware unit using read-only memory (ROM) or any other static or writable memory as described in this disclosure. Alternatively or additionally, hardware units and/or modules may be combined with and/or in communication with a processor, such as without limitation in a system-on-chip architecture wherein some functions are configured by modification or design of hardware circuitry, such as without limitation FPGA circuitry, while others are configured in the form of instructions in memory for one or more processors. As a non-limiting example, any step or combination of steps described herein may be performed entirely using hardware circuit configured to perform such steps either with static memory or rewritable memory. Such steps or combinations of steps may include signing with a digital signature, cryptographically hashing, evaluation of zero-knowledge proofs, or any other specific process described in this disclosure.

With continued reference to FIG. 1, computing device 104 may be designed and/or configured to perform any method, method step, or sequence of method steps in any embodiment described in this disclosure, in any order and with any degree of repetition. For instance, computing device 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. computing device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, computing device 104 may include at least one processor 108. The at least one processor 108 may be communicatively connected to a memory 112. Memory 112 may contain instructions configuring the at least one processor 108 to perform one or more actions as described throughout this disclosure.

With continued reference to FIG. 1, memory 112 may include instructions configuring processor 108 to select an entity model 116 from an entity model database 120. Entity model database 120 may be implemented, without limitation, as a relational database, a key-value retrieval database such as a NOSQL database, or any other format or structure for use as a database that a person skilled in the art would recognize as suitable upon review of the entirety of this disclosure. Entity model database 120 may alternatively or additionally be implemented using a distributed data storage protocol and/or data structure, such as a distributed hash table or the like. Entity model database 120 may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

With continued reference to FIG. 1, entity model 116 may include a LIDAR mask 124. In some embodiments, LIDAR mask 124 may filter out data that is not part of entity model 116. For example, LIDAR mask 124 may include a plurality of LIDAR datapoints of entity model 116.

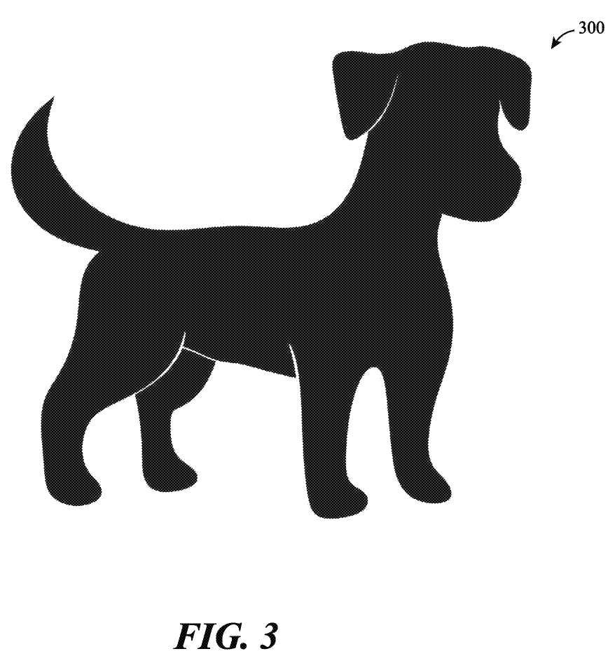

With continued reference to FIG. 1, entity model 116 may include an RGB mask 128. RGB mask 128 may include, as a non-limiting example, color data for the entity of entity model 116. RGB mask 128 may include, as a non-limiting example, camera data for the entity of entity model 116. In some embodiments, RGB mask 128 may define the entity’s silhouette which includes corresponding RGB image pixels. An exemplary data mask is described further with respect to FIG. 3. Entity model 116 may include a unified mask, wherein the unified mask may allow for separation of the from the background for both RGB cameras and LIDARs.

With continued reference to FIG. 1, LIDAR mask 124 and/or RGB mask 128 may include a bounding box. Bounding box may include a box that surrounds the entity in relation to its environment. As non-limiting examples, entity model 116 may include LIDAR point clouds, bounding boxes, camera data, RGB data, and the like. In some embodiments, entity model 116 may include LIDAR point cloud properties, like GT annotations for the points.

With continued reference to FIG. 1, in some embodiments, entity model 116 may include a rare entity model. Rare entities may include, as non-limiting examples, dogs, cats, scooters, robots, birds, carriages, and the like. A rare entity may be rare in the context of its environment, where as it may not be considered rare in another environment. As a non-limiting example, a baby stroller may not be considered a rare entity in general, but it would be a rare entity if encountered on a highway. In some embodiments, rare entities may include people or objects in unusual poses; as non-limiting examples, lying, running, jumping, standing upside down, or doing parkour. Rare entities may include, as non-limiting examples, ambulances, people holding something (heavy objects, stop signs, umbrellas) , private airplanes, bicycles/scooters on highways, overturned vehicles, fallen trees, elephants, and/or medieval knights. A rare entity model is a model of a rare entity. For a non-limiting example, rare entity model may include a model of a dog, model of a bird, model of a robot, model of a cat, model of a scooter, model of a carriage, and the like. Rare entities may include entities that cars may not see very often – but, they need to be able to respond properly when they do see them. By creating training data by augmenting scenes with rare entities, this disclosure provides a way to train object detection, object avoidance, or other self-driving algorithms how to respond to rare entities. This represents an improvement over the prior art where algorithms struggle in performance when confronted with rare entities.

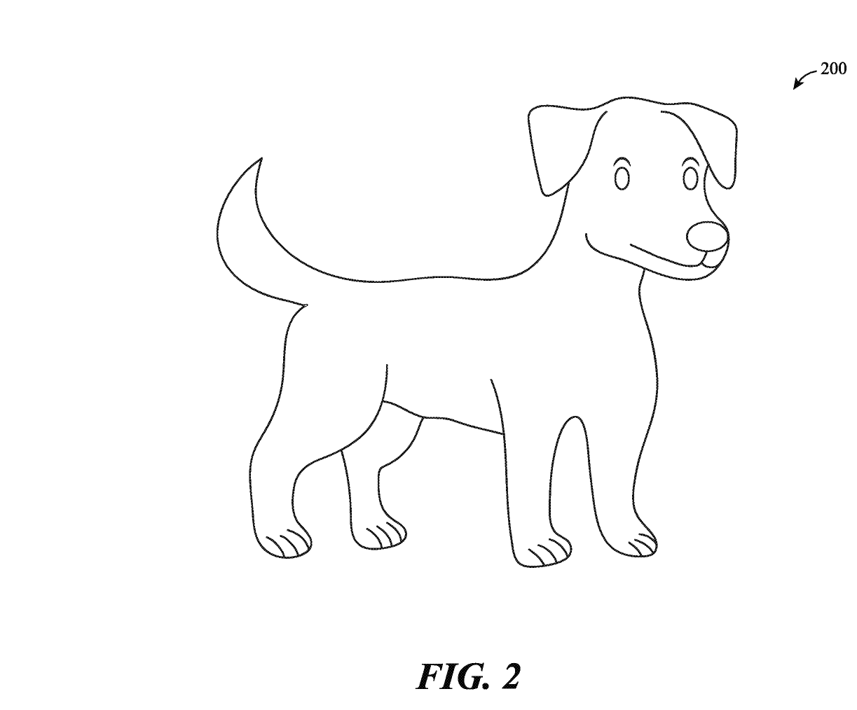

Referring now to FIG. 2, an exemplary entity model 200 is shown. Those skilled in the art, after having reviewed the entirety of this disclosure, would appreciate that while exemplary entity model 200 is depicted in FIG. 2 as a two-dimensional (2D) object, that entity model may represent a three-dimensional (3D) object. In some embodiments, exemplary entity model 200 may be a rare entity model. For example, in some embodiments, exemplary entity model 200 may include a rare entity model of a dog.

Referring now to FIG. 3, an exemplary data mask 300 is shown. Data mask 300 may include an RGB data mask. Data mask 300 may define an entity’s silhouette which includes corresponding RGB image pixels.

Referring back to FIG. 1, memory 112 may include instructions configuring processor 108 to select a random entity model 116 from entity model database 120. For example, entity model database 120 may include a plurality of entity models 116. Processor 108 may be configured to randomly select one or more of the plurality of entity models 116. This may serve to prevent bias in the selection of entity model 116.

With continued reference to FIG. 1, entity model 116 may be constructed primarily of data from an original autonomous vehicle. Autonomous vehicles, such as those equipped with LIDAR and/or camera sensors may gather data regarding the environments that they encounter. This may happen passively; i.e., autonomous vehicles may store data that they collect from environments as they go about their tasks. In some cases, these autonomous vehicles will encounter rare entities. As non-limiting examples, a dog may run into the road, or a delivery robot may cross the street. As part of its data collection, the autonomous vehicle may collect data on this rare entity.

With continued reference to FIG. 1, entities or rare entities may be manually identified within the data from the original autonomous vehicles. For example, a user may identify a dog that ran into the car, or a construction worker that was in the road. These identified entities / rare entities may be saved to entity model database 120 as entity models 116 / rare entity models.

With continued reference to FIG. 1, entities may be captures when they are close to the vehicle. This may allow for more detailed entity models. This is the case at least because LIDAR beams spread out as they move further from the LIDAR sensor, decreasing the density of data gathered. Additionally, camera resolution limits the detail of an image, thereby limiting the data captured for far away objects. As such, using entities that are close to the vehicle for entity model 116 may be beneficial.

With continued reference to FIG. 1, memory 112 may include instructions configuring processor 108 to filter a plurality of entity models 116 in the entity model database 120 as a function of a threshold collection distance. Memory 112 may include instructions configuring processor 108 to select entity model 116 from the plurality of entity models where the collection distance is below the threshold collection distance. For example, if a dog was 3 m from a LIDAR sensor when it was scanned, the collection distance. In some embodiments, collection distance may include an average distance of an object from the sensor. This procedure may allow for processor 108 to select only entity models 116 that were collected when they were close to the autonomous vehicle. This may allow for selection of entity models 116 with a higher density of data. This may allow for better insertion into the 3D space.

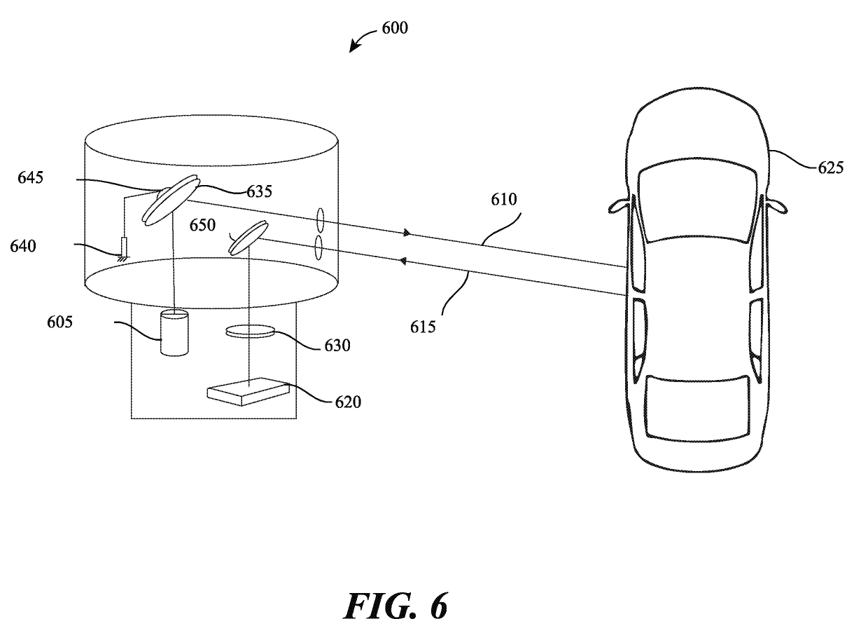

With continued reference to FIG. 1, memory 112 may include instructions configuring processor 108 to receive from an autonomous vehicle 132, a plurality of real-world LIDAR data 136 and real-world camera data 140. Real-world data may include data that has been collected from one or more scenarios in the real-world. For example, data collected by an autonomous vehicle 132 while it drives around a city would constitute real-world data. Real-world LIDAR data 136 is real-world data collected using a LIDAR sensor. LIDAR sensor is described further with reference to FIG. 6. Real-world camera data 140 is real-world data collected using a camera. For example, real-world camera data 140 may include images or videos collected using a camera.

With continued reference to FIG. 1, in some embodiments, real-world LIDAR data 136 and real-world camera data 140 may describe a three-dimensional (3D) space 144 at least partially surrounding autonomous vehicle 132. For example, 3D space 144 may include the road, pedestrians, traffic lights, signs, cityscape, crosswalks, other vehicles, or other objects that a vehicle commonly encounters. In some embodiments, 3D space 144 may include a 360 degree view of the surroundings of the vehicle. In embodiments, the distance from the vehicle determined by real world LIDAR data 136 may allow for the construction of the 3D space 144.

With continued reference to FIG. 1, memory 112 may include instructions configuring processor 108 to conduct an insertion process 148 to insert entity model 116 into 3d space 144. Memory 112 may include instructions configuring processor 108 to determine an insertion position 152 of entity model 116. In some embodiments, insertion position 152 may be generated using pre-defined angle and distance intervals.

With continued reference to FIG. 1, determining insertion position 152 of entity model 116 may include determining an overlap metric 160 as a function of insertion position 152 and entity model 116. In some embodiments, overlap metric 160 may be a measure of whether the entity model 116 overlaps with existing objects at insertion position 152. This may be determined using LIDAR mask 124 for entity model 116 and plurality of real-world LIDAR data 136 for 3D space 144. As a non-limiting example, processor 108 may compare the LIDAR datapoints associated with entity model 116 with plurality of real-world LIDAR data 136 to determine if one conflicts with the other. In some embodiments, processor 108 may be configured to determine which real-world LiDAR rays are occluded by the inserted object using knowledge of the object’s silhouette and its geometry (as a non-limiting example, via the LiDAR point cloud corresponding to the inserted object in the original scene from which it was extracted). For example, at a distance of 10 meters and a chosen angle, plurality of real-world LIDAR data 136 may indicate that there is no object for 20 meters at one side of entity model 116 but that there is only no object for 8 meters at a second side of entity model 116. Thus, overlap may be detected. overlap metric 160 may be, as non-limiting examples, a percent overlap or a value on a scale. The determination of an overlap metric 160 may determine the feasibility of the insertion by ensuring that the inserted entity does not overlap with existing objects in the scene and does not cast excessive shadows on existing objects in 3D space.

With continued reference to FIG. 1, if an overlap metric 160 exceeds a feasibility threshold, then processor 108 may be configured to automatically determine a new insertion position 152. In some embodiments, this may be performed iteratively until a feasible selection (i.e. where overlap metric 160 falls below a feasibility threshold) is found. In some embodiments, additionally, processor 108 may be configured to iteratively repeat insertion process 148 until a desired number of entity model 116 are inserted. In some embodiments, this may include conducting the steps of insertion process 148 in series. Or alternatively, some processes may occur in parallel. As a non-limiting example, insertion positions 152 for every entity model 116 desired to be inserted by be determined (and feasibility checked) before proceeding to RGB or LIDAR ray casting as described further below.

With continued reference to FIG. 1, memory 112 may include instructions configuring processor 108 to insert entity model 116 into 3D space 144. In some embodiments, this may include inserting entity model 116 into 3D space 144 to form augmented data 156. Augmented data 156 is real-world data that has been augmented to include one or more entity models 116.

With continued reference to FIG. 1, inserting entity model 116 into 3D space 144 may include performing an RGB ray-casting procedure. RGB ray-casting procedure. In some embodiments, this may include updating RGB image pixels (e.g., from real-world camera data 140 with pixels from the inserted entity model 116. This may include, in some embodiments, using RGB mask 128 to insert the pixels from entity model 116 For example, RGB mask 128 may define the entity’s silhouette, thereby indicating which pixels from entity model 116 should be inserted. This RGB ray casting procedure may help insure realistic visual integration of the entity model 116 into 3D space 144.

With continued reference to FIG. 1, insertion process 148 may include performing a LIDAR ray-casting procedure. LIDAR ray-casting procedure may include determining a plurality of projected LIDAR points 164, wherein plurality of projected LIDAR points 164 comprise locations where rays from the LIDAR system of autonomous vehicle 132 would intersect entity model 116. In some embodiments, determining plurality of projected LIDAR points 164 may be a function of LIDAR system parameters and an entity location. Entity location may include insertion position 152. LIDAR system parameters may include, as non-limiting examples, a LIDAR scan rate, point density, vertical spacing, scan patterns, and the like. In some embodiments, plurality of projected LIDAR points 164 may be determined using a geometric algorithm that projects LIDAR beams from the LIDAR system outward according to the LIDAR system’s parameters.

With continued reference to FIG. 1, memory 112 may include instructions configuring processor 108 to determine depth values 168. Depth values 168 are the distance from the LIDAR system to the particular plurality of projected LIDAR points 164 on entity model 116. In some embodiments, depth values 168 may be determined using LIDAR mask 124 of entity model 116. For example, in some embodiments, LIDAR mask 124 may include depth values relative to an original LIDAR sensor that collected entity model 116. Geometric computations may be used to determine depth values 168 which are relative to LIDAR system of autonomous vehicle 132 using insertion position 152.

With continued reference to FIG. 1, insertion process 148 may include geometrically modeling, as a function of depth values 168 and projected LIDAR points 164, return locations 172 for LIDAR rays that hit projected LIDAR points 164. For example, this may include determining a reflection of a LIDAR ray based on depth values 168. The updating of LIDAR point cloud for 3D space 144 may further include a LIDAR ray-casting procedure that is employed to generate a physically accurate LiDAR point cloud representation of the inserted entity. In certain aspects, LIDAR ray-casting procedure may use RGB mask 128 defining the entity’s silhouette. Particularly, the generated points (e.g., plurality of projected LIDAR points 164) maybe designed to closely resemble those that would be captured by a real LIDAR sensor. In some embodiments, a height value 176 of the inserted object may be determined using a road level 180. Road level 180 may be inherited from 3D space 144. In some embodiments, road level 180 may be determined by one or more sensing system on autonomous vehicle 132. In some embodiments, entity model 116 may be located at road level. In some embodiments, entity model 116 may be located above road level (e.g., where entity model 116 is a bird). In these cases, the height values 176 for entity model may be adjusted using road level 180 to integrate entity model 116 into 3D space 144.

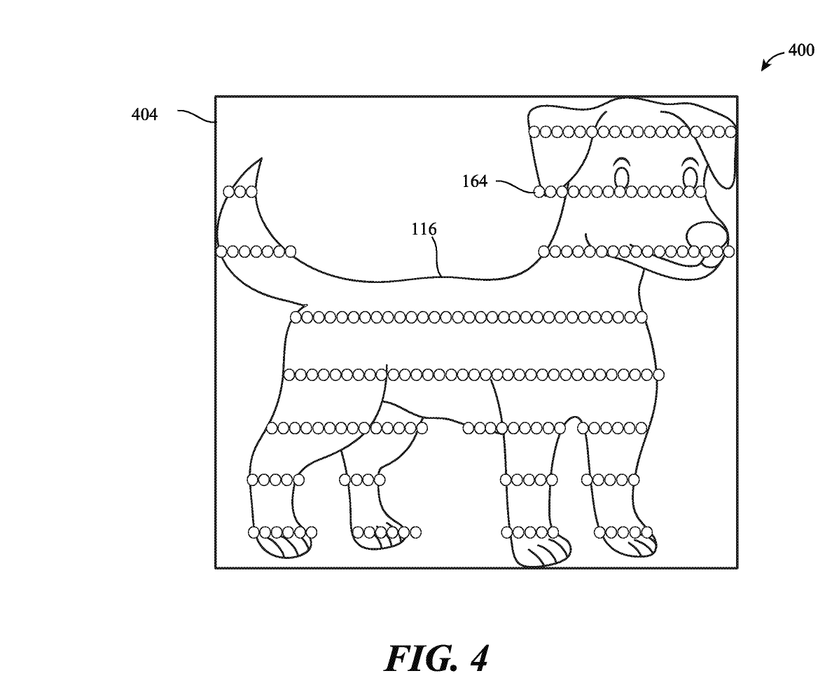

Referring now to FIG. 4, an exemplary embodiment 400 of plurality of projected LIDAR points 164 on an entity model 116 is shown. Exemplary embodiment 400 may include a bounding box 404, which may surround entity model 116. Plurality of LIDAR points 164 may be spaced out in lines as set by LIDAR system parameters. For examples, a LIDAR system may be capable of a certain horizontal points spacing (depending on the objects distance from the LIDAR system) and a certain vertical spacing; this may be reflected by plurality of projected LIDAR points 164. Plurality of projected LIDAR points 164 represent the projected locations where the rays from a LIDAR system of autonomous vehicle 132 will meet entity model 116. Plurality of projected LIDAR points 164 are not the original lidar points from the original scene (e.g., LIDAR mask 124). In some embodiments, plurality of projected LIDAR points 164 may be determined using a scanning pattern of LIDAR system of autonomous vehicle 132.

With continued reference to FIG. 4, interpolation may be used to interpolate between the LIDAR points in LIDAR mask 124 and plurality of projected LIDAR points 164. For example, this may be needed when the collected LIDAR points in LIDAR mask 124 do not correspond with plurality of projected LIDAR points 164; this may be, as non-limiting examples, due to different scanning patterns between LIDAR systems, different parameters between LIDAR systems, different road levels 180, and different distances between the entity model 116 and the LIDAR system. In some embodiments, linear interpolation may be used to interpolate between different LIDAR points. In some embodiments, local plane interpolation may be used to interpolate between different LIDAR points. Local plane interpolation may be used to unknown values at plurality of projected LIDAR points 164 by fitting multiple, separate polynomial planes to small, overlapping neighborhoods of data points. In this manner, data for plurality of projected LIDAR points 164 (e.g., depth values 168) may be determined. This is an improvement over other methods because it allows for the realistic insertion of entity model 116 into a scene and takes into account the locations at which the LIDAR sensor would measure entity model 116 in the scene to improve the insertion.

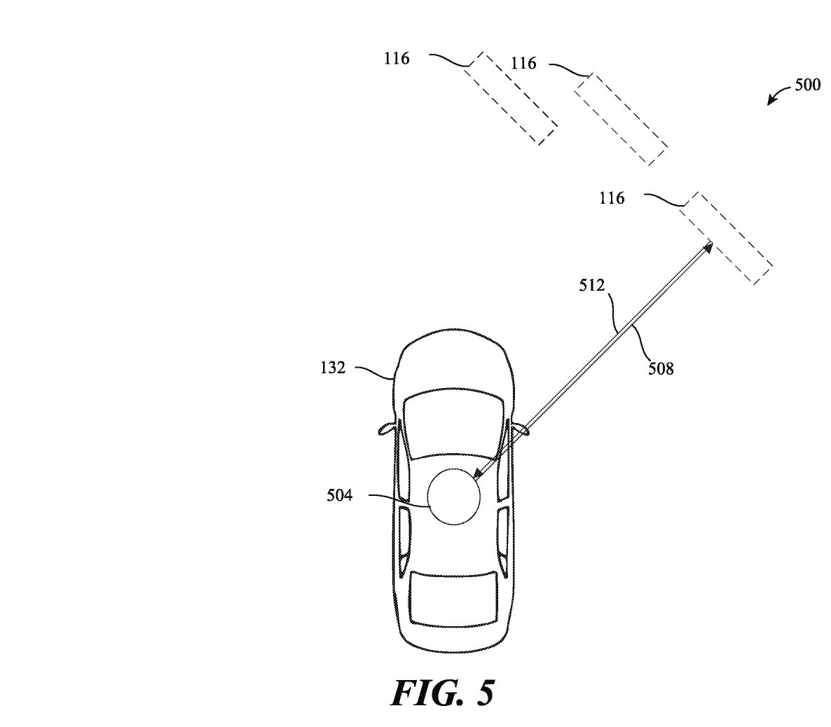

Referring now to FIG. 5, an exemplary embodiment 500 of a 3D space is shown. Autonomous vehicle 132 may include a LIDAR sensor 504. LIDAR sensor 504 may be further described with reference to FIG. 6. LIDAR sensor 504 may generate an output ray 508. Output ray 508 is a ray of light that is used by LIDAR sensor 504 to measure its surrounding environment. Output ray 508 may be a simulated ray (e.g., using ray casting) as described throughout this disclosure. For example, output ray 508 may contact an entity model 116 that has been inserted into the scene. Output ray 508 may contact entity model 116 at plurality of projected LIDAR points 164 and a return ray 512 may reflect from entity model 116 towards LIDAR sensor 504. Return ray 512 may be received by LIDAR sensor 504 and used to determine a distance of entity model 116 from LIDAR sensor 504; for example, using the time from the emission of output ray 508 to the reception of return ray 512. In some embodiments, as part of ray-casting procedure, a return location for return ray 512 may be geometrically computed based on plurality of projected LIDAR points 164 and entity model 116. This process of ray-casting for the LIDAR rays allows for the accurate determination of shadows. Shadows are areas where LIDAR rays are blocked, e.g., by other objects. This may represent an improvement over existing methods as this method allows for accurate simulation of shadows relative to the LIDAR sensor when inserting entities into a scene which improves the realism.

Referring back to FIG. 1, in some embodiments, memory 112 may include instructions configuring processor 108 to iteratively insert entity model 116 into 3D space 144. This may include iteratively inserting entity model 116 into 3D space 144 until a number of inserted entity models 116 reaches a desired number of entity models 116. As a non-limiting example, if a desired number of entity models 116 is 5, then processor 108 may iteratively repeat one or more aspects of insertion process 148 until 5 entity models 116 have been inserted into 3D space 144.

With continued reference to FIG. 1, memory 112 may include instructions configuring processor 108 to import, into augmented data 156, at least a label associated with the entity from the entity model database 120. For example, label may include “dog.” This label may be imported from entity model database 120 into augmented data 156 as part of insertion process 148. In some embodiments, this may be referred to as label inheritance. Label inheritance may include the labeling of the inserted entity being inherited and including point classification (e.g., object type) and 3D bounding box placement.

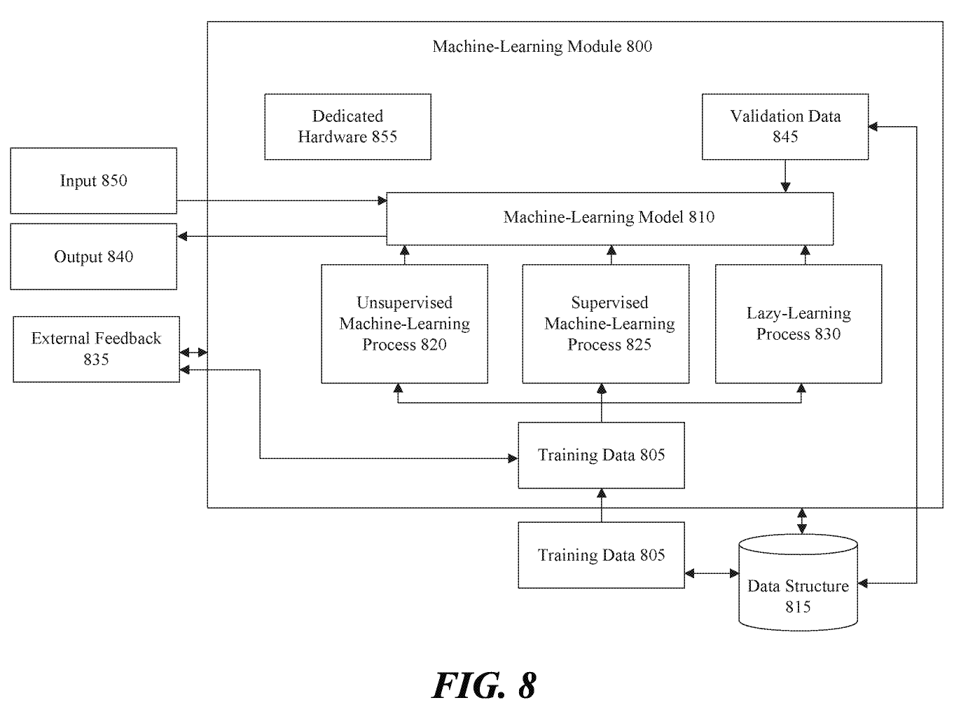

With continued reference to FIG. 1, memory 112 may include instructions configuring processor 108 to train an object detection neural network 184 as a function of the augmented data 156. In some embodiments, augmented data 156 may include an inserted entity model and a label. In some embodiments, training of object detection neural network 184 may be conducted using, as a non-limiting example, machine-learning module 800 as described further with respect to FIG. 8. In some embodiments, training data may include augmented data 156 and the label for the entity. The training technique may include the augmented scenes and their corresponding labels being used to train a neural network for object detection. In certain aspects, the neural network is optimized to improve its perception performance for rare entities. This training of object detection neural network 184 represents a clear technical improvement over existing methods. This allows for the synthetic generation of training data with entities in it, whereas it would be difficult and time consuming to generate this training data organically. Additionally, in the instance of rare entities, this also represents a technical improvement. Rare entities are, by definition, uncommon. Therefore, autonomous vehicles may not see them very often. Therefore, there is a need to train autonomous vehicles to respond when confronted with a rare entity. This augmented data training method solves this technical problem by providing a way to insert rare entities into scenes to form training data that includes rare entities. This would otherwise prove time consuming, costly, and difficult to generate this training data as rare entities do not occur in the wild often. In some embodiments, the data augmentation method disclosed herein is not limited to a detection task; as non-limiting examples, the data augmentation methods disclosed herein may also be applied to any 3D perception task, such as segmentation or classification. For example, data augmentation method disclosed herein may be used to generate training data for a segmentation model. Segmentation model may include a segmentation neural network and/or segmentation machine learning model. For example, data augmentation method disclosed herein may be used to generate training data for a classification model. Classification model may include a classification neural network and/or classification machine learning model. For example, classification raining data may be generated using tagged object classifications for the inserted objects.

With continued reference to FIG. 1, memory 112 may include instructions configuring processor 108 to insert entity model 116 into a sequence of scenes (e.g., a sequence of 3D spaces 144). For example, sequence of scenes may include scenes collected at a spacing of 100 ms during the same ride. In some embodiments, this may include determining a common insertion position 152 for all of the scenes in the sequence and calculating an overlap metric 160 for each of those scenes. If the overlap metric 160 for each scene in the series passes, then entity model 116 may be inserted into each of the scenes in the series at insertion position 152.

### Exemplary LIDAR System

Referring now to FIG. 6, a light detection and ranging (LIDAR) system 600 is a system that uses lasers to measure distances as a function of measuring reflected light. In some embodiments, LIDAR system 600 may include a light amplification by stimulated emission of radiation component (i.e., a laser).

With continued reference to FIG. 6, LIDAR system 600 may include a laser component 605 that may emit an emitted laser beam 610 and LIDAR system 600 may detect when they reflect back to the LIDAR system 600 in the form of returning beams 615 of light. A “laser component,” for the purposes of this disclosure, is a device that emits a laser beam through a process of optical amplification based on the stimulated emission of electromagnetic radiation. A “laser beam,” for the purposes of this disclosure, is a stream of light that is emitted from a laser component. In some embodiments, laser component 605 may be configured to emit infrared light. In some embodiments, laser component 605 may be configured to emit near-infrared light. In some embodiments, laser component 605 may be configured to emit short-wavelength infrared light. In some embodiments, laser component 605 may emit light with a wavelength of 905 nm and 1550 nm.

LIDAR system 600 may include a Light sensor 620. Light sensor 620 may be configured to detect returning beams of light. Light sensor 620 may be configured to both detect light and the time at which light is detected. In some embodiments, Light sensor 620 may include a photodiode. A photodiode is a semiconductor diode sensitive to photon radiation, such as visible light, infrared or ultraviolet radiation, X-rays and gamma rays. Photodiode may produce an electrical current when it absorbs photons. Photodiode may include a PIN structure or p–n junction. As a non-limiting example, when a photon of sufficient energy strikes the diode, it creates an electron–hole pair. This mechanism is also known as the inner photoelectric effect. If the absorption occurs in the junction's depletion region, or one diffusion length away from it, these carriers may be swept from the junction by the built-in electric field of the depletion region. Thus, in examples, holes move toward the anode, and electrons toward the cathode, and a photocurrent is produced. The total current through the photodiode may be the sum of the dark current (current that is passed in the absence of light) and the photocurrent. Dark current may be minimized to maximize the sensitivity of the device.

With continued reference to FIG. 6, in some embodiments, processor 108 may be communicatively connected to Light sensor 620 and configured to receive light detection data from Light sensor 620. Light detection data may include, as non-limiting examples, intensity data and/or temporal data. Temporal data may include a time (or times) at which light is detected. In some embodiments, processor 108 may be configured to determine a distance metric as a function of the light detection data. For example, if an object 625 is farther away from a LIDAR system 600 light emitted from LIDAR system 600 will take longer to reflect back and be detected by Light sensor 620; thus, it can be inferred that the object 625 that reflected the light is further away. Conversely, if an object 625 is closer to a LIDAR system 600 light emitted from LIDAR system 600 will take a shorter amount of time to reflect back and be detected by Light sensor 620; thus, it can be inferred that the object 625 that reflected the light is closer. In some embodiments, laser component may include mechanical-type LIDAR.

With continued reference to FIG. 6, LIDAR system 600 may include an interference filter 630. Interference filter 630 may be configured to filter out interfering signals such that the interfering signals do not reach light sensor 620. For example, interference filter 630 may be configured to filter visible light such that visible light does not reach light sensor 620. Interference filter 630 is configured to allow returning beam 615 to allow returning beam 615 to reach light sensor 620.

With continued reference to FIG. 6, LIDAR system 600 may include one or more mirrors or reflective surfaces. The mirrors or reflective surfaces may be configured to redirect and/or reflect emitted laser beam 610 and/or returning beam 615. As a non-limiting examples, LIDAR system 600 may include a scanning mirror 635. Sanning mirror 635 may be configured to reflect an emitted laser beam 610 from a laser component 605 out of LIDAR system 600 and towards, e.g., object 625.

With continued reference to FIG. 6, scanning mirror 635 may be configured to rotate about a vertical axis. As a non-limiting example, this may allow LIDAR system 600 to scan a 360 degree area as scanning mirror 635 is rotated about the vertical axis. In some embodiments, scanning mirror 635 may be configured to rotate about a transverse axis. As a non-limiting example, this may allow lidar system 600 to adjust the scanning area vertically.

With continued reference to FIG. 6, scanning mirror 635 may be operatively connected to an actuator. Actuator may include a component of a machine that is responsible for moving and/or controlling a mechanism or system. Actuator may, in some embodiments, require a control signal and/or a source of energy or power. In some cases, a control signal may be relatively low energy. Exemplary control signal forms include electric potential or current, pneumatic pressure or flow, or hydraulic fluid pressure or flow, mechanical force/torque or velocity, or even human power. In some cases, an actuator may have an energy or power source other than control signal. This may include a main energy source, which may include for example electric power, hydraulic power, pneumatic power, mechanical power, and the like. In some embodiments, upon receiving a control signal, actuator responds by converting source power into mechanical motion. In some cases, actuator may be understood as a form of automation or automatic control.

Still referring to FIG. 6, in some embodiments, actuator may include a hydraulic actuator. A hydraulic actuator may consist of a cylinder or fluid motor that uses hydraulic power to facilitate mechanical operation. Output of hydraulic actuator may include mechanical motion, such as without limitation linear, rotatory, or oscillatory motion. In some embodiments, hydraulic actuator may employ a liquid hydraulic fluid. As liquids, in some cases, are incompressible, a hydraulic actuator can exert large forces. Additionally, as force is equal to pressure multiplied by area, hydraulic actuators may act as force transformers with changes in area (e.g., cross sectional area of cylinder and/or piston). An exemplary hydraulic cylinder may consist of a hollow cylindrical tube within which a piston can slide. In some cases, a hydraulic cylinder may be considered single acting. “Single acting” may be used when fluid pressure is applied substantially to just one side of a piston. Consequently, a single acting piston can move in only one direction. In some cases, a spring may be used to give a single acting piston a return stroke. In some cases, a hydraulic cylinder may be double acting. “Double acting” may be used when pressure is applied substantially on each side of a piston; any difference in resultant force between the two sides of the piston causes the piston to move.

Still referring to FIG. 6, in some embodiments, actuator may include a pneumatic actuator mechanism. In some cases, a pneumatic actuator may enable considerable forces to be produced from relatively small changes in gas pressure. In some cases, a pneumatic actuator may respond more quickly than other types of actuators such as, for example, hydraulic actuators. A pneumatic actuator may use compressible fluid (e.g., air). In some cases, a pneumatic actuator may operate on compressed air. Operation of hydraulic and/or pneumatic actuators may include control of one or more valves, circuits, fluid pumps, and/or fluid manifolds.

Still referring to FIG. 6, in some cases, actuator may include an electric actuator. Electric actuator may include any of electromechanical actuators, linear motors, and the like. In some cases, actuator may include an electromechanical actuator. An electromechanical actuator may convert a rotational force of an electric rotary motor into a linear movement to generate a linear movement through a mechanism. Exemplary mechanisms, include rotational to translational motion transformers, such as without limitation a belt, a screw, a crank, a cam, a linkage, a scotch yoke, and the like. In some cases, control of an electromechanical actuator may include control of electric motor, for instance a control signal may control one or more electric motor parameters to control electromechanical actuator. Exemplary non-limitation electric motor parameters include rotational position, input torque, velocity, current, and potential. Electric actuator may include a linear motor. Linear motors may differ from electromechanical actuators, as power from linear motors is output directly as translational motion, rather than output as rotational motion and converted to translational motion. In some cases, a linear motor may cause lower friction losses than other devices. Linear motors may be further specified into at least 3 different categories, including flat linear motor, U-channel linear motors and tubular linear motors. Linear motors may be directly controlled by a control signal for controlling one or more linear motor parameters. Exemplary linear motor parameters include without limitation position, force, velocity, potential, and current.

Still referring to FIG. 6, in some embodiments, an actuator may include a mechanical actuator. In some cases, a mechanical actuator may function to execute movement by converting one kind of motion, such as rotary motion, into another kind, such as linear motion. An exemplary mechanical actuator includes a rack and pinion. In some cases, a mechanical power source, such as a power take off may serve as power source for a mechanical actuator. Mechanical actuators may employ any number of mechanisms, including for example without limitation gears, rails, pulleys, cables, linkages, and the like.

With continued reference to FIG. 6, in some embodiments, actuator may include a vertical actuator 640. Vertical actuator 640 may be consistent with any of the actuators described above. Vertical actuator 640 may be configured to rotate scanning mirror 635 around a vertical axis. In some embodiments, actuator may include a transverse actuator 645. Transverse actuator 645 may be consistent with any of the actuators described above. Transverse actuator 645 may be configured to rotate scanning mirror 635 around a transverse axis.

With continued reference to FIG. 6, lidar system 600 may include a sensor mirror 650. Sensor mirror 650 may be configured to reflect returning beam 615 to light sensor 620.

### Exemplary Vehicle Computing Architecture

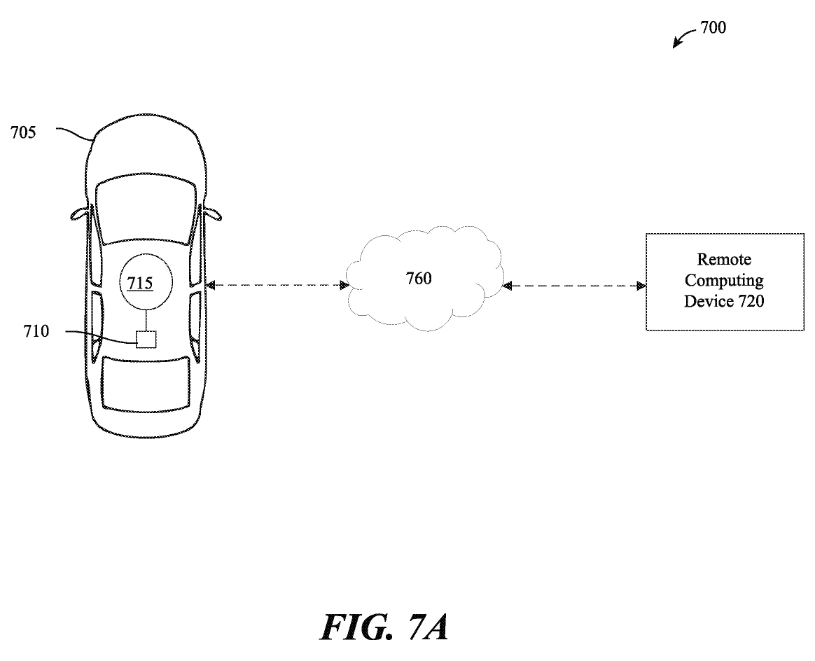

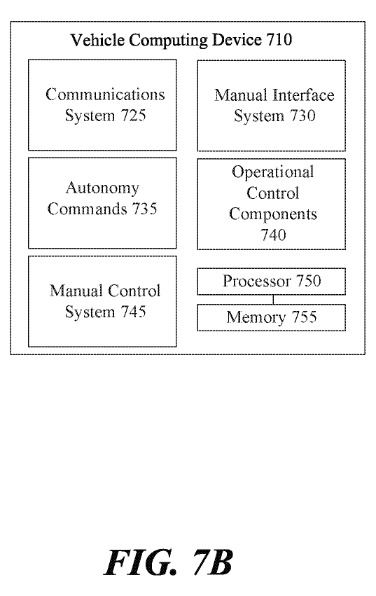

Referring now to FIGS. 7A and 7B, an exemplary vehicle computing architecture 700 is shown. Vehicle computing architecture 700 may include a vehicle 705. A “vehicle,” for the purposes of this disclosure is a device that is designed to transport goods, people, and/or animals. In some embodiments, vehicle 705 may be motorized. As non-limiting examples, vehicle 705 may include a car, a scooter, an ebike, an ATV, a motorcycle, a motorbike, a minibike, a truck, a golf cart, an aircraft, and the like. In some embodiments, vehicle 705 may be human-powered. As non-limiting examples, vehicle 705 may include a bike, a rickshaw, a skateboard, a scooter, or the like.

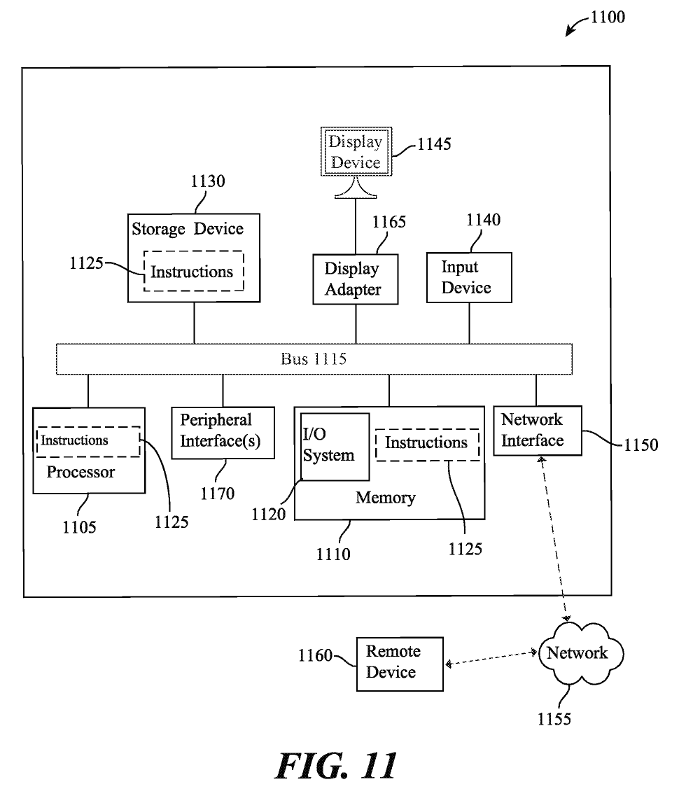

With continued reference to FIGS. 7A AND 7B, the vehicle 705 may be an autonomous vehicle that may drive, navigate, operate, etc. with minimal and/or no interaction from a human driver. Vehicle 705 may include a vehicle computing device 710 that implements a variety of systems on- board the vehicle 705. In some embodiments, vehicle computing device 710 may be consistent with aspects of computing device 1100 described further with respect to FIG. 11.

With continued reference to FIGS. 7A and 7B, in some embodiments, vehicle computing architecture 700 may include one or more data acquisition systems 715. A data acquisition systems 715 may include a plurality of sensors configured to detect data from the environment surrounding or inside of vehicle 705. In some embodiments, data acquisition system 715 may include one or more cameras. Cameras may include, as non-limiting examples, wide-angle cameras, high-resolution cameras, panoramic cameras, two-dimensional cameras, three-dimensional cameras, video cameras, and the like. In some embodiments, data acquisition system 715 may include one or more LIDAR sensors. In some embodiments, data acquisition system 715 may include one or more ultrasound sensors. For example, ultrasound sensors may be mounted around the perimeter of vehicle 705. In some embodiments, ultrasound sensors may be located on the corners of vehicle 705. In some embodiments, ultrasound sensors may be used for object detection and/or collision avoidance. In some embodiments, data acquisition system 715 may include one or more microphones. In some embodiments, microphones may be arranged in an array. In some embodiments, microphones may include directional microphones. In some embodiments, microphones may include unidirectional microphones. In some embodiments data acquisition system 715 may include one or more RADAR sensors. In some embodiments, data acquisition system 715 may include, as non-limiting examples, lane detectors, optical readers, electric eyes, and/or other suitable types of image capture devices.

With continued reference to FIGS. 7A and 7B, vehicle computing device 710 may include a plurality of vehicle computing devices 710. As a non-limiting example, in some embodiments, vehicle computing device 710 may include, a central computing device and one or more auxiliary computing devices. In some embodiments, auxiliary computing devices may be located on or in the vehicle 705 roof. In some embodiments, auxiliary computing devices may be located close to certain sensors of data acquisition system 715 that they are configured to process data for. For example, auxiliary computing devices configured to process camera data may be located near cameras. For example, auxiliary computing devices configured to process LIDAR data may be located near LIDAR sensors. This may serve, for example, as an edge computing implementation, wherein, for example, data processing for certain sensors or sources of data may be offloaded to auxiliary computing devices that are closer to the sensors of sources of data of interest. This may beneficially impact data processing as it allows for data to be processed sooner after it is collected.

With continued reference to FIGS. 7A and 7B, the vehicle 705 may be configured to enter into a ready state. The ready state may indicate that the vehicle 705 is ready to operate (and/or return to) an autonomous navigation mode. A computing device on-board the vehicle 705 may be configured to determine whether the vehicle 705 is in the ready state. A remote computing device 720 (e.g., associated with an operations control center) may indicate that the vehicle 705 is ready to begin and/or resume autonomous navigation.

With continued reference to FIGS. 7A and 7B, for instance, the vehicle computing system 710 may include a communications system 725, one or more manual interface systems 730, one or more data acquisition systems 715, an autonomy command 735, one or more operational control components 740, and/or a manual control system 745.

With continued reference to FIGS. 7A and 7B, the manual interface systems 730 may be configured to allow interaction between a user (e.g., human) and the vehicle 705 (e.g., the vehicle computing system 710). The manual interface systems 730 may include a variety of interfaces for the user to input and/or receive information from the vehicle computing system 710. The manual interface systems 730 may include one or more input device(s) (e.g., touchscreens, keypad, touchpad, knobs, buttons, sliders, switches, mouse, gyroscope, microphone, other hardware interfaces) configured to receive user input. The manual interface systems 730 may include a user interface (e.g., graphical user interface, conversational and/or voice interfaces, chatter robot, gesture interface, other interface types) for receiving user input.

With continued reference to FIGS. 7A and 7B, vehicle computing system 710 may include a processor 750 and a memory 755. Processor 750 and memory 755 may be consistent with other processors and memory described throughout this disclosure. Processor 750 and memory 755 may be communicatively connected. Memory 755 may contain instructions (e.g., software) configured to cause processor 750 to perform one or more actions in accordance with this disclosure.

With continued reference to FIGS. 7A and 7B, vehicle computing architecture 700 may include a remote computing device 720. the remote computing device 720 may include and/or otherwise be associated with one or more computing devices (e.g., computing device 1100, referred to in FIG. 11) that are remote from the vehicle 705. The remote computing device 720 may communicate with the vehicle 705 via one or more communications networks 760. The communications network 760 may include various wired and/or wireless communication mechanisms (e.g., cellular, wireless, satellite, microwave, and radio frequency) and/or any desired network topology. For example, the communications network 760 may include a local area network (e.g. intranet), wide area network (e.g. Internet), wireless LAN network (e.g., via Wi-Fi), cellular network, a SATCOM network, VHF network, a HF network, a WiMAX based network, and/or any other suitable communications network (or combination thereof) for transmitting data to and/or from the vehicle 705.

### Exemplary Machine-Learning Module

Referring now to FIG. 8, an exemplary embodiment of a machine-learning module 800 is shown. Machine-learning module 800 may be configured to perform one or more machine learning processes as described throughout this disclosure. Machine-learning module 800 may perform determinations, classification, and/or analysis steps, methods, processes, or the like as described in this disclosure using machine learning processes. A “machine learning process,” as used in this disclosure, is a process that automatedly uses training data 805 to generate one or more machine-learning models 810.

With continued reference to FIG. 8, for the purposes of this disclosure, “training data” is data that contains correlations that a machine-learning process may use to model relationships between two or more types of data. For example, training data 805 may include one or more training examples. Multiple data entries in training data 805 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. In some embodiments, training data 805 may include input training data correlated to output training data. Input training data may include, as a non-limiting example augmented data as described further throughout this disclosure. Output training data may include, as a non-limiting example labels or object detection information as described further throughout this disclosure. Elements in training data 805 may be linked to descriptors of categories by tags, tokens, or other data elements; for instance, and without limitation, training data 805 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

With continued reference to FIG. 8, in some embodiments, training data 805 may be divided into different formats, categories, and/or groups. For example, in some embodiments, training data 805 may be divided into one or more cohorts, categorizations, time periods, data sources, and the like. In some embodiments, training data 805 may be assigned to categories using a classifier; as a non-limiting example, a training data classifier. Training data classifier may include a machine-learning module as described elsewhere with respect to FIG. 8. For example, in some embodiments, training data 805 may be input into training data classifier and training data classifier may output a classification. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 800 may generate a classifier using a classification algorithm, defined as a processes whereby a computing device and/or any module and/or component operating thereon derives a classifier from training data 805. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher’s linear discriminant, quadratic classifiers, decision trees, boosted trees, random forest classifiers, learning vector quantization, and/or neural network-based classifiers. In some embodiments, training data 805 may be classified into one or more categories such as geographic areas, types of entities, types of rare entities, LIDAR system models, software versions, and the like.

With continued reference to FIG. 8, training data 805 may be retrieved, in some embodiments, from a data structure 815. A data structure 815 may be remote to a computing device and communicative with a computing device by way of one or more networks. Network may include, but not limited to, a cloud network, a mesh network, or the like. By way of example, a “cloud-based” system, as that term is used herein, can refer to a system which includes software and/or data which is stored, managed, and/or processed on a network of remote servers hosted in the “cloud,” e.g., via the Internet, rather than on local servers or personal computers. A “mesh network” as used in this disclosure is a local network topology in which the infrastructure a computing device connect directly, dynamically, and non-hierarchically to as many other computing devices as possible. A “network topology” as used in this disclosure is an arrangement of elements of a communication network. data structure 815 may be implemented, without limitation, as a relational database, a key-value retrieval database such as a NOSQL database, or any other format or structure for use as a database that a person skilled in the art would recognize as suitable upon review of the entirety of this disclosure. data structure 815 may alternatively or additionally be implemented using a distributed data storage protocol and/or data structure, such as a distributed hash table or the like. data structure 815 may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure. In an embodiment, data structure 815 may be a generic storage mechanism. A generic storage mechanism may be a storage system or method that is not specific to any particular type or format of data, that is, a storage solution that provides a flexible and adaptable way to store and retrieve data without being tied to a specific data format, schema, or domain. In some embodiments, training data 805 may be stored in data structure 815. In some embodiments, training data 805 may be retrieved from data structure 815.

With continued reference to FIG. 8, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

With continued reference to FIG. 8, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

With continued reference to FIG. 8, a “machine-learning model,” as used in this disclosure, is a data structure representing and/or instantiating a mathematical and/or algorithmic representation of a relationship between inputs and outputs as generated using any machine-learning process. For example, machine-learning process may include, without limitation, any machine-learning process described in this disclosure.

With continued reference to FIG. 8, machine-learning process may include an unsupervised machine-learning process 820. An unsupervised machine-learning process, as used herein, is a process that derives inferences in datasets without regard to labels; as a result, an unsupervised machine-learning process may be free to discover any structure, relationship, and/or correlation provided in the data. Unsupervised processes machine-learning process 820 may not require a response variable; unsupervised processes machine-learning process 820 may be used to find interesting patterns and/or inferences between variables, to determine a degree of correlation between two or more variables, or the like.

With continued reference to FIG. 8, machine-learning process may include a supervised machine-learning process 825. Supervised machine-learning process 825 may use training data 805 with both exemplary inputs and expected outputs and use that training data 805 to train a machine-learning model 810. For example, during a training process, machine learning process may evaluate an actual output generated by machine-learning model 810 and compare it to an expected output from training data 805. Based on the difference between the actual and expected outputs, one or more weights within machine-learning model 810 may be updated. For example, in some cases a scoring function may be used to train machine-learning model 810. Scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 805.

With continued reference to FIG. 8, machine-learning process may include a lazy-learning process 830. Lazy learning is a machine-learning approach in which the model delays generalization until a query is made. For example, this can be rather than learning a global model during training. Instead of building an abstract representation of the data up front, a lazy learner may store the training instances and wait until it needs to make a prediction. For example, when a new input arrives, the system may perform computation on the fly. Because no heavy training occurs in advance, lazy-learning algorithms may be fast to set up but can be computationally expensive at prediction time and often require storing large datasets in memory. An example may include k-nearest neighbors (k-NN), which classifies new points based on the labels of their closest neighbors in the stored data. Lazy learning may adapt naturally to new data because the “model” is effectively the dataset itself, but this also means it can be sensitive to noise and may not scale well with very large datasets.

With continued reference to FIG. 8, in some embodiments, machine-learning module 800 may receive external feedback 835. External feedback 835 may include, as a non-limiting example, feedback received from a user. In some embodiments, external feedback 835 may be received through a user interface (such as, for example, a graphical user interface (GUI).

With continued reference to FIG. 8, machine-learning module 800 may be configured to re-train machine-learning model 810. In some embodiments, re-training machine-learning model 810 may include re-training machine-learning model 810 as a function of external feedback 835. In some embodiments, external feedback 835 may serve as a source of labeled or partially labeled data that reflects how the model performs in real-world conditions. For example, if a user provides negative external feedback 835, then the set of data from training data 805 may be assigned a negative label. In some embodiments, external feedback 835 may include users correcting an output 840 of machine-learning model 810—such as flagging an incorrect prediction, choosing a preferred recommendation, or providing explicit labels. These interactions can be collected and added back into the training dataset. Over time, this additional data may help the model adapt to new patterns, correct systematic errors, and better align with user expectations. The re-training process may include cleaning and validating external feedback 835, merging it with existing datasets such as training data 805, and/or periodically running a new training cycle to update model parameters.

With continued reference to FIG. 8, machine-learning module 800 may be configured to validate machine-learning model 810. In some embodiments, machine-learning module 800 may validate machine-learning model 810 using validation data 845. Validation data 845 may be a subset of data used to train machine-learning model 805. For example, validation data 845 may include a subset of training data 805. In some embodiments, validation data 845 may include a percentage of training data 805. As non-limiting example, validation data 845 may include 1%,2%, 5%, 10%, 20%, 30%, and the like of training data 805. In some embodiments, machine-learning model 810 may not be exposed to validation data 845 during training. Validation data 845 may acts as a checkpoint that helps determine whether the model is generalizing well or simply memorizing training data 805. As the model learns, its performance on the validation set may be monitored to guide decisions such as choosing hyperparameters, selecting architectures, adjusting regularization strength, or determining when to stop training to avoid overfitting.

With continued reference to FIG. 8, machine-learning model 810 may be configured to receive one or more inputs 850 and generate, as a function of the one or more inputs 850, one or more outputs 840. Outputs 840 may be presented to users for example trough user interfaces and/or GUIs. In some embodiments, external feedback 835 may be received users as a function of output 840.

With continued reference to FIG. 8, one or more, processes, machine-learning processes, actions, steps, or the like as disclosed above may be performed using dedicated hardware 855. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware 855 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware 855 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware 855 to perform one or more operations described herein, such as evaluation of model and/or algorithm outputs, one-time or iterative updates to parameters, coefficients, weights, and/or biases, and/or any other operations such as vector and/or matrix operations as described in this disclosure.

### Exemplary Neural Network

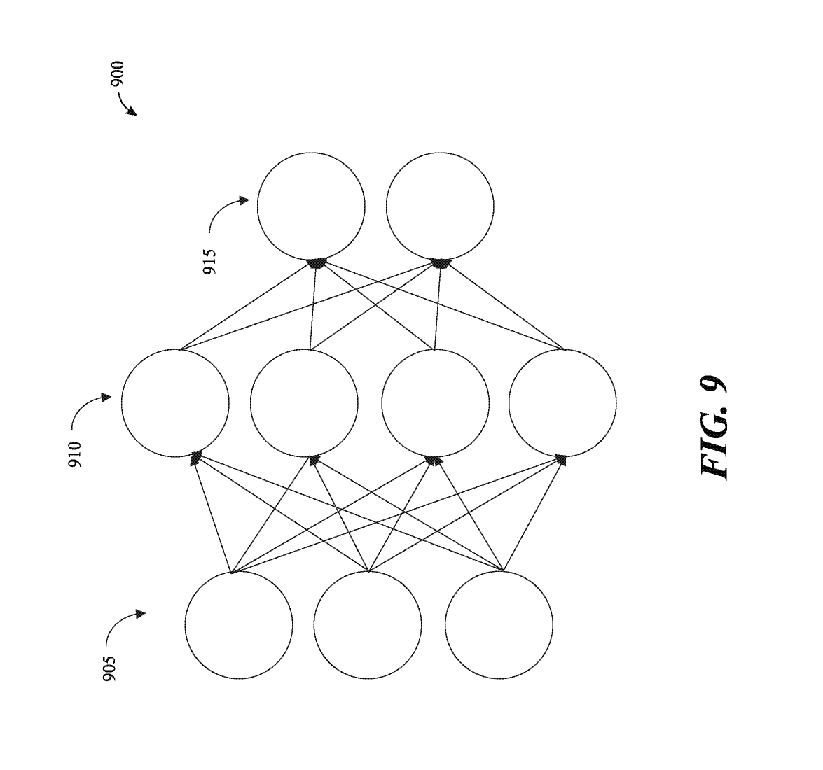

Referring now to FIG. 9, an exemplary embodiment of neural network 900 is illustrated. A neural network 900 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 905, one or more intermediate layers 910, and an output layer of nodes 915. Connections between nodes may be created using a process of "training" the network, in which elements from a training dataset may applied to the input nodes. A suitable training algorithm (such as Levenberg-Marquardt, conjugate gradient, simulated annealing, or other algorithms) may then be used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like. Neural networks, as described in this disclosure, are not limited to any particular type or architecture of neural networks; as non-limiting examples, neural network may include architectures based on convolutional layers, attention mechanisms, and/or transformer blocks.

### Method for Synthetic Entity Augmentation in Autonomous Vehicle Perception Systems

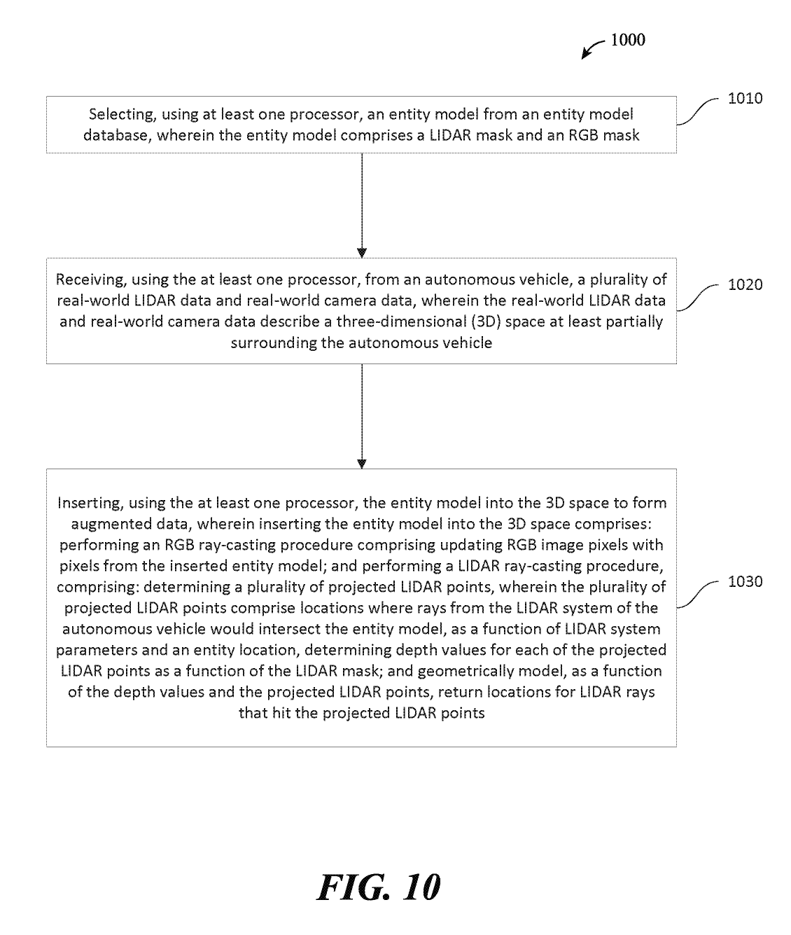

Referring now to FIG. 10, a method 1000 for synthetic entity augmentation in autonomous vehicle perception systems is shown. Method 1000 includes a step 1010 of selecting, using at least one processor, an entity model from an entity model database, wherein the entity model includes a LIDAR mask and an RGB mask. This may be accomplished as described, without limitation, with reference to FIGS. 1-9.

With continued reference to FIG. 10, method 1000 includes a step 1020 of receiving, using the at least one processor, from an autonomous vehicle, a plurality of real-world LIDAR data and real-world camera data, wherein the real-world LIDAR data and real-world camera data describe a three-dimensional (3D) space at least partially surrounding the autonomous vehicle. This may be accomplished as described, without limitation, with reference to FIGS. 1-9.

With continued reference to FIG. 10, method 1000 includes a step 1030 of inserting, using the at least one processor, the entity model into the 3D space to form augmented data, wherein inserting the entity model into the 3D space includes: performing an RGB ray-casting procedure including updating RGB image pixels with pixels from the inserted entity model; and performing a LIDAR ray-casting procedure, including: determining a plurality of projected LIDAR points, wherein the plurality of projected LIDAR points include locations where rays from the LIDAR system of the autonomous vehicle would intersect the entity model, as a function of LIDAR system parameters and an entity location; determining depth values for each of the projected LIDAR points as a function of the LIDAR mask; and geometrically model, as a function of the depth values and the projected LIDAR points, return locations for LIDAR rays that hit the projected LIDAR points. This may be accomplished as described, without limitation, with reference to FIGS. 1-9.

With continued reference to FIG. 10, in some aspects, the techniques described herein relate to a method, wherein inserting the entity model into the 3D space includes determining a height value for the inserted entity model as a function of a road level. This may be accomplished as described, without limitation, with reference to FIGS. 1-9.

With continued reference to FIG. 10, in some aspects, the techniques described herein relate to a method, further including iteratively inserting, using the at least one processor, the entity model into the 3D space until a number of inserted entity models reaches a desired number of entity models. This may be accomplished as described, without limitation, with reference to FIGS. 1-9.

With continued reference to FIG. 10, in some aspects, the techniques described herein relate to a method, importing, using the at least one processor, into the augmented data, at least a label associated with the entity from the entity model database. This may be accomplished as described, without limitation, with reference to FIGS. 1-9.

With continued reference to FIG. 10, in some aspects, the techniques described herein relate to a method, training, using the at least a processor, an object detection neural network as a function of the augmented data including the inserted entity model and the at least a label, wherein the object detection neural network is configured to detect objects. This may be accomplished as described, without limitation, with reference to FIGS. 1-9.

With continued reference to FIG. 10, in some aspects, the techniques described herein relate to a method, wherein the entity model is a rare entity. This may be accomplished as described, without limitation, with reference to FIGS. 1-9.

With continued reference to FIG. 10, in some aspects, the techniques described herein relate to a method, wherein the entity model is constructed primarily of data from an original autonomous vehicle. This may be accomplished as described, without limitation, with reference to FIGS. 1-9.

With continued reference to FIG. 10, in some aspects, the techniques described herein relate to a method, wherein selecting the entity model from the entity model database includes: filtering a plurality of entity models in the entity model database as a function of a threshold collection distance; and selecting the entity model from the entity models where the collection distance is below the threshold collection distance. This may be accomplished as described, without limitation, with reference to FIGS. 1-9.

With continued reference to FIG. 10, in some aspects, the techniques described herein relate to a method, further including: determining, using the at least one processor, an insertion position of the entity model; and determining, using the at least one processor, an overlap metric as a function of the insertion position and the entity model, wherein the overlap metric is a measure of whether the entity model overlaps with existing objects at the insertion position. This may be accomplished as described, without limitation, with reference to FIGS. 1-9.

With continued reference to FIG. 10, in some aspects, the techniques described herein relate to a method, further including iteratively generating, using the at least one processor, new insertion positions for the entity model until the overlap metric indicates that the entity does not overlap with existing objects at the insertion position. This may be accomplished as described, without limitation, with reference to FIGS. 1-9.

### Exemplary Computing Device

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

FIG. 11 shows a diagrammatic representation of one embodiment of a computing device in the exemplary form of a computer system 1100 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1100 includes a processor 1105 and a memory 1110 that communicate with each other, and with other components, via a bus 1115. Bus 1115 may include any of several types of bus structures including, but not limited to, a memory bus, a memory controller, a peripheral bus, a local bus, and any combinations thereof, using any of a variety of bus architectures.

Processor 1105 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1105 may be organized according to Von Neumann and/or Harvard architecture as a non-limiting example. Processor 1105 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC). Each processor and/or processor core may perform a state transition, instruction, and/or instruction step during a period of a “clock,” or a regular oscillator that generates periodic output waveform, such as a square wave, having a regular period; different processors and/or cores may have distinct clocks. A processor may operate as and/or include a processing unit that performs instruction inputs, arithmetic operations, logical operations, memory retrieval operations, memory allocation operations, and/or input and output operations; a control circuit or module within a processor may determine which of the above-described functions a processor and/or unit within a processor will perform on a given clock cycle. A processor may include a plurality of processing units or “cores,” each of which performs the above-described actions; multiple cores may work on disparate instruction sets and/or may work in parallel. A single core may also include multiple arithmetic, logic, or other units that can work in parallel with each other. Parallel computing between and/or within processors and/or cores may include multithreading processes and/or protocols such as without limitation Tomasulo’s algorithm. As used in this disclosure, “a processor,” and/or “configuring a processor,” is equivalent for the purposes of this disclosure to at least a processor, a plurality of processors, and/or a plurality of processor cores, and/or programming at least a processor, a plurality of processors, and/or a plurality of processor cores, which may be configured to operate on instructions in parallel and/or sequentially according to multithreading algorithms, parallel computing, load and/or task balancing, and/or virtualization, for instance and without limitation as described below.

Memory 1110 may include various components (e.g., machine-readable media) including, but not limited to, a random-access memory component, a read only component, and any combinations thereof. In one example, a basic input/output system 1120 (BIOS), including basic routines that help to transfer information between elements within computer system 1100, such as during start-up, may be stored in memory 1110. Memory 1110 may also include (e.g., stored on one or more machine-readable media) instructions (e.g., software) 1125 embodying any one or more of the aspects and/or methodologies of the present disclosure. In another example, memory 1110 may further include any number of program modules including, but not limited to, an operating system, one or more application programs, other program modules, program data, and any combinations thereof. Memory 1110 may include a primary memory and a secondary memory. “Primary memory,” which may be implemented, without limitation as “random access memory” (RAM), is memory used for temporarily storing data for active use by a processor. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power.

Computer system 1100 may also include a storage device 1130. Examples of a storage device (e.g., storage device 1130) include, but are not limited to, a hard disk drive, a magnetic disk drive, an optical disc drive in combination with an optical medium, a solid-state memory device, and any combinations thereof. Storage device 1130 may be connected to bus 1115 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1130 (or one or more components thereof) may be removably interfaced with computer system 1100 (e.g., via an external port connector (not shown)). Particularly, storage device 1130 and an associated machine-readable medium may provide nonvolatile and/or volatile storage of machine-readable instructions, data structures, program modules, and/or other data for computer system 1100. In some embodiments, storage device 1130 and/or devices “Secondary memory” also known as “storage,” “hard disk drive” and the like for the purposes of this disclosure is a long-term storage device in which an operating system and other information is stored; operating system and/or main program instructions may alternatively or additionally be stored in hard-coded memory ROM, or the like. In one or remote embodiments, information may be retrieved from secondary memory and copied to primary memory during use. In one or more embodiments, secondary memory may be referred to as non-volatile memory wherein information is preserved even during a loss of power. In some embodiments, data from secondary memory is transferred to primary memory before being accessed by a processor. In one or more embodiments, data is transferred from secondary to primary memory wherein circuitry may access the information from primary memory. In one example, software (e.g., instructions 1125) may reside, completely or partially, within machine-readable medium . In another example, software may reside, completely or partially, within processor 1105.

.Computer system 1100 may also include an input device 1140. In one example, a user of computer system 1100 may enter commands and/or other information into computer system 1100 via input device 1140. Examples of an input device 1140 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1140 may be interfaced to bus 1115 via any of a variety of interfaces (not shown) including, but not limited to, a serial interface, a parallel interface, a game port, a USB interface, a FIREWIRE interface, a direct interface to bus 1115, and any combinations thereof. Input device 1140 may include a touch screen interface that may be a part of or separate from display 1145, discussed further below. Input device 1140 may be utilized as a user selection device for selecting one or more graphical representations in a graphical interface as described above.

A user may also input commands and/or other information to computer system 1100 via storage device 1130 (e.g., a removable disk drive, a flash drive, etc.) and/or network interface device 1150. A network interface device, such as network interface device 1150, may be utilized for connecting computer system 1100 to one or more of a variety of networks, such as network 1155, and one or more remote devices 1160 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1155, may employ a wired and/or a wireless mode of communication. In general, any network topology may be used. Information (e.g., data, software, etc.) may be communicated to and/or from computer system 1100 via network interface device 1150.

Computer system 1100 may further include a video display adapter 1165 for communicating a displayable image to a display device, such as display 1145. Examples of a display device include, but are not limited to, a liquid crystal display (LCD), a cathode ray tube (CRT), a plasma display, a light emitting diode (LED) display, and any combinations thereof. Display adapter 1165 and display 1145 may be utilized in combination with processor 1105 to provide graphical representations of aspects of the present disclosure. In addition to a display device, computer system 1100 may include one or more other peripheral output devices including, but not limited to, an audio speaker, a printer, and any combinations thereof. Such peripheral output devices may be connected to bus 1115 via a peripheral interface 1170. Examples of a peripheral interface include, but are not limited to, a serial port, a USB connection, a FIREWIRE connection, a parallel connection, and any combinations thereof.

Further referring to FIG. 11, a computing device may include any computing device as described in this disclosure, including without limitation a microcontroller, microprocessor, digital signal processor (DSP) and/or system on a chip (SoC) as described in this disclosure. A computing device may include, be included in, and/or communicate with a mobile device such as a mobile telephone or smartphone. A computing device may include a single device having components as described above operating independently, or may include two or more such devices and/or components thereof operating in concert, in parallel, sequentially or the like; two or more devices, processors, memory elements, and the like may be included together in a single computing device or in two or more computing devices. A computing device may interface or communicate with one or more additional devices as described below in further detail via a network interface device.

In some embodiments, and still referring to FIG. 11, a computing device may be a component of a combination of at least a computing device; at least a computing device may include, as a non-limiting example, a first computing device or cluster of computing devices in a first location and a second computing device or cluster of computing devices in a second location. At least a computing device may include one or more computing devices dedicated to data storage, security, distribution of traffic for load balancing, and the like. At least a computing device may distribute one or more computing tasks as described below across a plurality of computing devices of computing device, which may operate in parallel, in series, redundantly, or in any other manner used for distribution of tasks or memory between computing devices. At least a computing device may be implemented, as a non-limiting example, using a “shared nothing” architecture.

With continued reference to FIG. 11, one or more programs or software instructions may include a principal program and/or operating system; principal program and/or operating system may be a program that runs automatically upon startup of a computing device and manages computer hardware and software resources. Principal program and/or operating system may include “startup,” “loop,” and/or “main” programs on a microcontroller; such programs may initialize hardware resources and subsequently iterate through a series of instructions to make function calls, read in data at input ports, output data at output ports, and process interrupts caused by asynchronous data inputs or the like. Principal program and/or operating system may include, without limitation, an operating system, which may schedule program tasks to be implemented by one or more processors, act as an intermediary between one or more programs and inputs, outputs, hardware and/or memory. Examples of operating systems include without limitation Unix, Linux, Microsoft Windows, Android, Disc Operating System (DOS) and the like. Operating systems may include, without limitation, multi-computer operating systems that run across multiple computing devices, real-time operating systems, and hypervisors. A “hypervisor,” as used in this disclosure, is an operating system that runs a virtual machine and/or container, where virtual machines and/or containers create virtual interfaces for programs that mimic the behavior of hardware elements such as processors and/or memory; interactions with such virtual interfaces appear, to programs executed on virtual machines, to function as interactions with physical hardware, while in reality the hypervisor and/or programs such as containers (1) receive inputs from programs to the virtual resources and allocate such inputs to physical hardware that is not directly accessible to the programs, and (2) receive outputs from physical hardware and transmit such outputs to the programs in the form of apparent outputs from the virtual hardware. In some cases, one or more of computing system 1100, processor 1105, and memory 1110 may be virtualized; that is, a virtual machine and/or container may interact directly with such computing system 1100, processor 1105, and/or memory 1110, while managing communications therefrom and thereto via a virtual interface with programs. Computer virtualization may include dividing, or augmenting computing resources into a virtual machine, operating system, processor, and/or container. Virtualization of computer resources may be implemented through use of (1) multiple components, or portions thereof, working in concert, as if they were one unified (virtual) component; and/or (2) a portion of one or more components working as though it were a complete (virtual) component. For instance, where processor 1105 comprises a plurality of processors and/or processor cores, virtualization may, in some cases, simulate or emulate a single (virtual) processor whose functions are allocated to one or more of the plurality of processors and/or processor cores. In this case, while processor 1105 may be said to be virtualized, the processor 1105, nevertheless, comprises actual hardware processor(s) or portion(s) thereof. Accordingly, in this disclosure, where a processor is said to perform instructions, such processor may comprise a virtualized processor, comprising a plurality or portion of hardware processors. Likewise, in this disclosure, where a memory is said to contain (i.e., store) instructions, such memory may comprise a virtualized memory, comprising a plurality or portion of memories. Technologies that enable such virtualization include (1) QEMU, www.qemu.org; (2) VMware by Broadcom Inc of Palo Alto, California; (3) VirtualBox by Oracle Corporation headquartered in Austin, Texas; and (4) kernel-based virtual machine (KVM) www.linux-kvm.org.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

Those skilled in the art will recognize, or be able to ascertain using no more than routine experimentation, numerous equivalents to the specific procedures, embodiments, claims, and examples described herein. Such equivalents were considered to be within the scope of this invention and covered by the claims appended hereto. For example, as discussed above, it should be understood that the particular system and method used to implement the disclosure may be modified without changing the spirit of the invention, and as such the various art-recognized alternatives are within the scope of the present application.

It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

The following examples further illustrate aspects of the present invention. However, they are in no way a limitation of the teachings or disclosure of the present invention as set forth herein.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

What is claimed is:

1. A system for synthetic entity augmentation in autonomous vehicle perception systems, the system comprising:
at least one processor; and
a memory, wherein the memory contains instructions configuring the at least one processor to:
select an entity model from an entity model database;
receive from an autonomous vehicle, a plurality of real-world LIDAR data and real-world camera data, wherein the real-world LIDAR data and real-world camera data describe a three-dimensional (3D) space at least partially surrounding the autonomous vehicle; and
insert the entity model into the 3D space to form augmented data, wherein inserting the entity model into the 3D space comprises:
performing an RGB ray-casting procedure comprising updating RGB image pixels with pixels from the inserted entity model; and
performing a LIDAR ray-casting procedure, comprising:
determining a plurality of projected LIDAR points, wherein the plurality of projected LIDAR points comprise locations where rays from the LIDAR system of the autonomous vehicle would intersect the entity model, as a function of LIDAR system parameters and an entity location;
determining depth values for each of the projected LIDAR points as a function of the LIDAR mask; and
geometrically model, as a function of the depth values and the projected LIDAR points, return locations for LIDAR rays that hit the projected LIDAR points.

2. The system of claim 1, wherein inserting the entity model into the 3D space comprises determining a height value for the inserted entity model as a function of a road level.

3. The system of claim 1, wherein the memory contains instructions further configuring the at least a processor to iteratively insert the entity model into the 3D space until a number of inserted entity models reaches a desired number of entity models.

4. The system of claim 1, wherein the memory contains instructions further configuring the at least a processor to import, into the augmented data, at least a label associated with the entity from the entity model database.

5. The system of claim 1, wherein the memory contains instructions further configuring the at least a processor to train an object detection neural network as a function of the augmented data comprising the inserted entity model and the at least a label, wherein the object detection neural network is configured to detect objects.

6. The system of claim 1, wherein the entity model is a rare entity.

7. The system of claim 1, wherein the entity model is constructed primarily of data from an original autonomous vehicle.

8. The system of claim 1, wherein selecting the entity model from the entity model database comprises:
filtering a plurality of entity models in the entity model database as a function of a threshold collection distance; and
selecting the entity model from the entity models where the collection distance is below the threshold collection distance.

9. The system of claim 1, wherein the memory contains instructions further configuring the at least a processor to:
determine an insertion position of the entity model; and
determine an overlap metric as a function of the insertion position and the entity model, wherein the overlap metric is a measure of whether the entity model overlaps with existing objects at the insertion position.

10. The system of claim 9, wherein the memory contains instructions further configuring the at least a processor to iteratively generate new insertion positions for the entity model until the overlap metric indicates that the entity does not overlap with existing objects at the insertion position.

11. A method for synthetic entity augmentation in autonomous vehicle perception systems, the method comprising:
selecting, using at least one processor, an entity model from an entity model database;
receiving, using the at least one processor, from an autonomous vehicle, a plurality of real-world LIDAR data and real-world camera data, wherein the real-world LIDAR data and real-world camera data describe a three-dimensional (3D) space at least partially surrounding the autonomous vehicle; and
inserting, using the at least one processor, the entity model into the 3D space to form augmented data, wherein inserting the entity model into the 3D space comprises:
performing an RGB ray-casting procedure comprising updating RGB image pixels with pixels from the inserted entity model; and
performing a LIDAR ray-casting procedure, comprising:
determining a plurality of projected LIDAR points, wherein the plurality of projected LIDAR points comprise locations where rays from the LIDAR system of the autonomous vehicle would intersect the entity model, as a function of LIDAR system parameters and an entity location;
determining depth values for each of the projected LIDAR points as a function of the LIDAR mask; and
geometrically model, as a function of the depth values and the projected LIDAR points, return locations for LIDAR rays that hit the projected LIDAR points.

12. The method of claim 11, wherein inserting the entity model into the 3D space comprises determining a height value for the inserted entity model as a function of a road level.

13. The method of claim 11, further comprising iteratively inserting, using the at least one processor, the entity model into the 3D space until a number of inserted entity models reaches a desired number of entity models.

14. The method of claim 11, importing, using the at least one processor, into the augmented data, at least a label associated with the entity from the entity model database.

15. The method of claim 11, training, using the at least a processor, an object detection neural network as a function of the augmented data comprising the inserted entity model and the at least a label, wherein the object detection neural network is configured to detect objects.

16. The method of claim 11, wherein the entity model is a rare entity.

17. The method of claim 11, wherein the entity model is constructed primarily of data from an original autonomous vehicle.

18. The method of claim 11, wherein selecting the entity model from the entity model database comprises:
filtering a plurality of entity models in the entity model database as a function of a threshold collection distance; and
selecting the entity model from the entity models where the collection distance is below the threshold collection distance.

19. The method of claim 11, further comprising:
determining, using the at least one processor, an insertion position of the entity model; and
determining, using the at least one processor, an overlap metric as a function of the insertion position and the entity model, wherein the overlap metric is a measure of whether the entity model overlaps with existing objects at the insertion position.

20. The method of claim 19, further comprising iteratively generating, using the at least one processor, new insertion positions for the entity model until the overlap metric indicates that the entity does not overlap with existing objects at the insertion position.
